(19) United States
(12) Patent Application Publication
(10) Pub. No.: US 2019/0100888 A1
(43) Pub. Date: Apr. 4, 2019

(54) HAND OPERATED PAINTING CART APPARATUS AND METHOD

(71) Applicants: Timothy Hand, Meadow Vista, CA (US); Jeanette Hand, Meadow Vista, CA (US); Daniel Hand, Dover, PA (US); Stephanie Hand, Dover, PA (US)

(72) Inventors: Timothy Hand, Meadow Vista, CA (US); Jeanette Hand, Meadow Vista, CA (US); Daniel Hand, Dover, PA (US); Stephanie Hand, Dover, PA (US)

(21) Appl. No.: 16/024,648

(22) Filed: Jun. 29, 2018

Related U.S. Application Data
(60) Provisional application No. 62/565,630, filed on Sep. 29, 2017.

(51) Int. Cl. E01C 23/22; B62B 3/10; B62B 3/00; B62B 5/06; E01F 9/518

(52) U.S. Cl. CPC E01C 23/22; B62B 3/10; E01F 9/518; B62B 5/06; B62B 3/008

(57) ABSTRACT

A hand operated painting cart apparatus is disclosed. The hand operated painting cart apparatus includes a wheeled base comprising a frame, a front pair of wheels connected by a front axle, and a rear pair of wheels connected by a rear axle. The wheeled base including at least one basket. A spray-holster is configured to retain a paint gun to the frame. A fifth-wheel assembly attached to the frame. The fifth-wheel assembly includes a wheel that is configured to engage, and alternatively, disengage with the ground. A handle connected to the wheeled base includes a first-hand trigger and a second-hand trigger. The first-hand trigger is configured to disengage the wheel of the fifth-wheel assembly from the ground. The second-hand trigger is configured to operate a paint gun. The hand operated painting cart apparatus may be useful for painting straight and curved lines on a surface.

### CROSS-REFERENCE TO RELATED APPLICATION(S)

The present application is related to and claims priority to U.S. Provisional Patent Application No. 62/565,630 filed Sep. 29, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of painting machines of existing art and more specifically relates to manually maneuverable painting carts.

### RELATED ART

Painting supplies used for larger projects such as roadways and parking lots are very heavy. Carrying all the supplies needed for painting is not feasible. Often a large compressor tank is coupled with a motor to draw paint from a reservoir. The paint then travels through a heavy rubber hose to a paint gun. Paint is very heavy, and the volume of paint needed to complete a task may weigh much more than a person can sustainably carry. Most painting professionals have difficulty in carrying the paint and associated accessories.

The device that painting professionals typically use have wheeled carts so the paint and associated accessories may be transported for convenience. Many of these painting supply transport carts have two, three, or four wheels. Often the carts also have an attachment to mount a paint gun such that the nozzle will point at a surface to be painted. The two wheeled carts prove difficult to paint straight lines, thus the advent of the three wheeled cart. While the three wheeled carts may provide a means of painting straight lines, the wheel must be retractable for maneuverability. When the wheel is retracted, the paint cart is not stable and will tip if unattended. The four wheeled carts have sufficient storage capacity and stability for carrying paint and associated supplies. However, with four freely rotatable wheels, the four wheeled cart does not provide the ability to reliably paint straight lines. A suitable solution is desired.

U.S. Pat. No. 7,237,783 to Joseph Kieffer relates to an accessory cart for striping pavement and other surfaces. The described accessory cart for striping pavement and other surfaces includes an accessory cart having a J-shaped frame for removable mounting of a spray gun to convert a conventional airless paint sprayer into a line striper to paint lines on parking lots, curbs, warehouse floors and other pavement surfaces, and which can alternately be used in conjunction with a traditional line striper in cramped spaces or between parked cars, and which is easily converted from a 3-wheeled device to a 2-wheeled device for painting curved lines, and which permits adjustable positioning of the spray gun at a desired location on the cart to optimize the spray pattern in a particular application.

### SUMMARY OF THE INVENTION

In view of the foregoing disadvantages inherent in the known manually maneuverable painting carts art, the present disclosure provides a novel hand operated painting cart apparatus. The general purpose of the present disclosure, which will be described subsequently in greater detail, is to provide an efficient and effective hand operated painting cart apparatus and method.

A hand operated painting cart apparatus is disclosed herein. The hand operated painting cart apparatus provides a functional manually maneuverable painting cart having four base wheels and, a fifth retractable wheel. The hand operated painting cart apparatus includes a wheeled base comprising a frame, a front pair of wheels connected by a front axle, and a rear pair of wheels connected by a rear axle. The wheeled base includes at least one basket. A handle is connected to the wheeled base and configured to be gripped by a user. The handle includes a first-hand trigger and a second-hand trigger. The first-hand trigger is disposed on the handle and configured to pull a first-wire. The second-hand trigger is also disposed on the handle and configured to pull a second-wire.

A spray-holster is included with the hand operated painting cart apparatus. The spray holster comprises a body having a paint-aperture and a retaining-aperture. The retaining-aperture is configured to retain the spray-holster to the wheeled base. The paint-aperture is configured to retain a paint gun to the spray-holster. The paint gun is structured and arranged to be actuated by the second-wire when the second-hand trigger is pulled. A fifth-wheel assembly is affixed to the wheeled base. The fifth-wheel assembly includes a lower-platform. The lower-platform has a forward-end, a rearward-end, a right side, a left side, a top-surface, and a bottom-surface. The top-surface includes a tubular pivoting-member extending from the right side to the left side a first distance from the forward-end.

The top-surface further includes a pivot-support located a second distance from the forward-end. The fifth-wheel apparatus includes an upper-platform. The upper-platform has a front-end, a back-end, a first-side, a second-side, and a lower-surface. The lower-surface includes a back-abutment member disposed from the first-side to the second-side on the back-end. A first-abutment member extends perpendicularly from the lower-surface of the front end of the upper-platform. The first-abutment member is configured to abut with the top-surface of the forward-end of the lower-platform. A retaining-member is configured to pivotably connect the upper-platform to the tubular pivoting-member of the lower-platform. The retaining-member is disposed a first distance from the front-end. A pivot-arm is pivotably connected to the pivot-support of the lower-platform and configured to abut with the back-abutment member of the upper-platform. The pivot-arm is configured to be pulled by the first wire.

According to another embodiment, a method of using a hand operated painting cart apparatus is also disclosed herein. The method of using a hand operated painting cart apparatus includes a first step of providing a hand operated painting cart apparatus; the hand operated painting cart apparatus (comprising: a wheeled base the wheeled base comprising a frame, a front pair of wheels connected by a front axle, and a rear pair of wheels connected by a rear axle). The wheeled base including at least one basket. A handle is connected to the wheeled base and configured to be gripped by a user. The handle includes a first-hand trigger and a second-hand trigger. The first-hand trigger is disposed on the handle and configured to pull a first-wire. The second-hand trigger is also disposed on the handle and configured to pull a second-wire. A spray-holster is included with the hand operated painting cart apparatus. The spray holster comprises a body having a paint-aperture and a retaining-aperture. The retaining-aperture configured to retain the spray-holster to the wheeled base.

The paint-aperture is configured to retain a paint gun to the spray-holster. The paint gun is configured to be actuated by the second-wire when the second-hand trigger is pulled. A fifth-wheel assembly is affixed to the wheeled base. The fifth-wheel assembly includes a lower-platform. The lower-platform having a forward-end, a rearward-end, a right side, a left side, a top-surface, and a bottom-surface. The top-surface includes a tubular pivoting-member extending from the right side to the left side a first distance from the forward-end. The top-surface further includes a pivot-support located a second distance from the forward-end. The fifth-wheel apparatus includes an upper-platform. The upper-platform has a front-end, a back-end, a first-side, a second-side, and a lower-surface. The lower-surface includes a back-abutment member disposed from the first-side to the second-side on the back-end. A first-abutment member extends perpendicularly from the lower-surface of the front end of the upper-platform. The first-abutment member is configured to abut with the top-surface of the forward-end of the lower-platform. A retaining-member is configured to pivotably connect the upper-platform to the tubular pivoting-member of the lower-platform. The retaining-member is disposed a first distance from the front-end. A pivot-arm is pivotably connected to the pivot-support of the lower-platform and configured to abut with the back-abutment member of the upper-platform. The pivot-arm is configured to be pulled by the first wire. Steps further include: Inserting the paint gun into the paint-aperture of the spray-holster; Mating the spray-holster to the frame through the retaining-aperture; Tightening the first-set-screw into the threaded set-retaining aperture to secure the spray-holster to the frame; Inserting the paint gun into the paint-aperture; Tightening the second-set-screw in in the threaded set-gun aperture to secure the spray-holster to the frame; the method further comprising the optional steps of: squeezing the first-hand trigger to disengage the wheel from the ground; Pushing the top-surface of the lower-platform of the fifth-wheel assembly to engage the wheel with the ground; and, squeezing the second-hand trigger to activate the paint gun.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hand operated painting cart apparatus, constructed and operative according to the teachings of the present disclosure.

FIG. 1 is a perspective view of the hand operated painting cart apparatus during an ‘in-use’ condition, according to an embodiment of the disclosure.

FIG. 2 is a perspective view of the hand operated painting cart apparatus of FIG. 1, according to an embodiment of the present disclosure.

FIG. 3 is a perspective view of the hand operated painting cart apparatus of FIG. 1, according to an embodiment of the present disclosure.

FIG. 4A is a perspective view of the hand operated painting cart apparatus of FIG. 1, according to an embodiment of the present disclosure.

FIG. 4B is a perspective view of the hand operated painting cart apparatus of FIG. 1, according to an embodiment of the present disclosure.

FIG. 5 is a flow diagram illustrating a method of using a wheeled spraying apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a manually maneuverable painting carts and more particularly to a hand operated painting cart apparatus as used to improve the existing manually maneuverable painting cart art.

Generally, the hand operated painting cart apparatus provides a functional manually maneuverable painting cart having four base wheels and, a fifth retractable wheel. The hand operated painting cart apparatus includes a wheeled base with an attached frame capable of carrying painting supplies. A spray-holster is configured to attach a paint gun to the frame for painting a surface. A handle is attached to the frame that includes a pair of two hand triggers. The first hand trigger is attached to a wire that is attachable to the paint gun. When the first hand trigger is activated, the wire is retracted, and the paint gun is activated. Decompressing the first hand trigger to its normal state will deactivate the paint gun. The second hand trigger is attached to the fifth wheel assembly. The second hand trigger is configured to retract the wheel of the fifth wheel assembly and disengage the wheel from the ground. The fifth wheel assembly comprises opposing upper and lower platforms pivotably connected by a retaining member. The lower platform has an attached wheel. The lower platform pivots such that the wheel is either engaged with the ground, and alternatively, retracted and disengaged with the ground. A first-abutment member is connected to the upper-platform and is configured to support the lower platform when the wheel is engaged with the ground. The second hand trigger is configured to retract a second wire that pulls a pivot arm. The pivot arm is pivotably attached to the lower platform and abuts with a back-abutment member attached to the upper-platform. When the second wire is retracted, the pivot arm disengages with the back-abutment member, allowing the lower platform to pivot and disengaging the wheel from the ground.

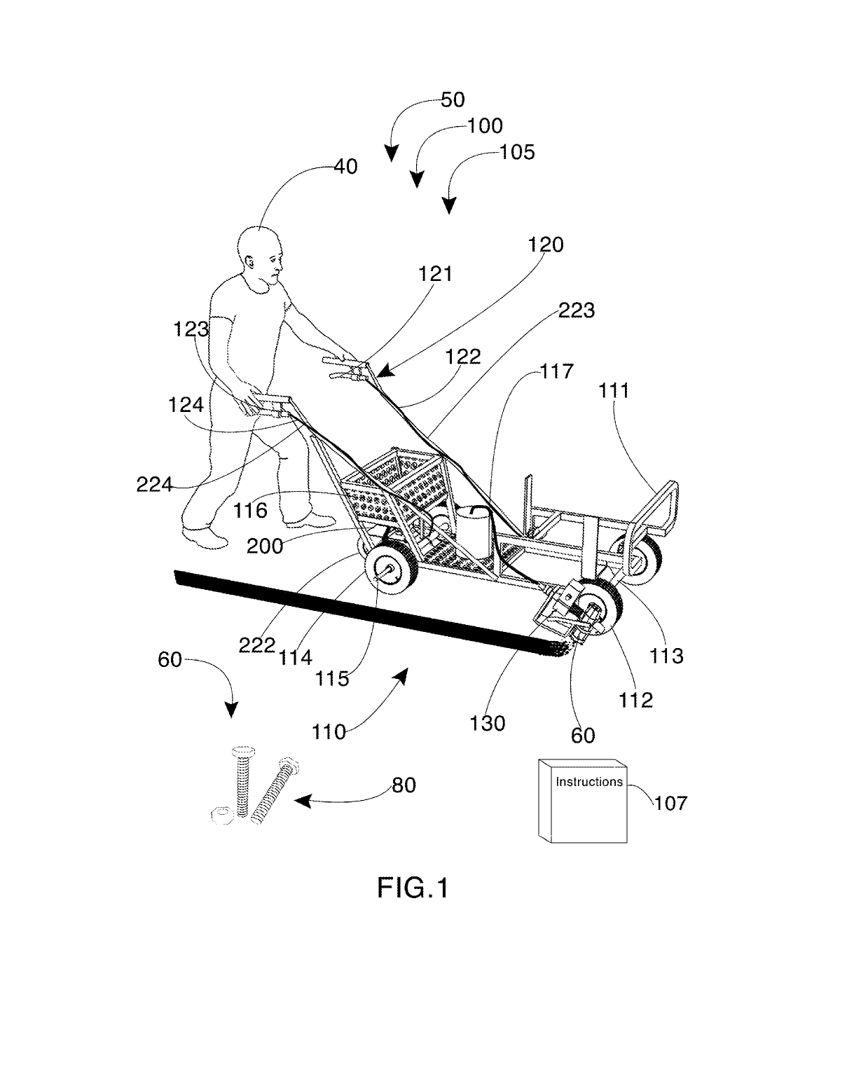

Referring now more specifically to the drawings by numerals of reference, there is shown in FIGS. 1-4B, various views of a hand operated painting cart apparatus 100.

FIG. 1 shows a hand operated painting cart apparatus 100 during an ‘in-use’ condition 50, according to an embodiment of the present disclosure. Here, the hand operated painting cart apparatus 100 may be beneficial for use by a user 40 to paint a surface. As illustrated, the hand operated painting cart apparatus 100 may include a wheeled base 110, the wheeled base 110 comprising a frame 111, a front pair of wheels 112 connected by a front axle 113, and a rear pair of wheels 114 connected by a rear axle 115. The wheeled base 110 includes at least one basket 116. The frame 111 includes at least one surface 117 configured to carry painting utilities/accessories. The frame 111 may be made of steel, and alternatively, another rigid material. Other considered rigid materials include carbon fiber, plastic composites and various metal alloys or the like.

A handle 120 is connected to the wheeled base 110 and configured to be gripped by a user 40. The handle 120 includes a first-hand trigger 121 and a second-hand trigger 123. The first-hand trigger 121 is configured to pull a first-wire 122. The first-wire 122 may include a rigid first-sheath 223 configured to protect the first-wire 122. The second-hand trigger 123 is configured to pull a second-wire 124. The second-wire 124 may include a rigid second-sheath 224 configured to protect the second-wire 124. The rigid first-sheath 223 and the rigid second-sheath 224 may be independently attached to the handle 120 and terminate in respective functional locations. The rigid first-sheath 223 and the rigid-second sheath 224 may comprise tubing that defines a passage for the first-wire 122 and the second-wire 124 to pass through respectively.

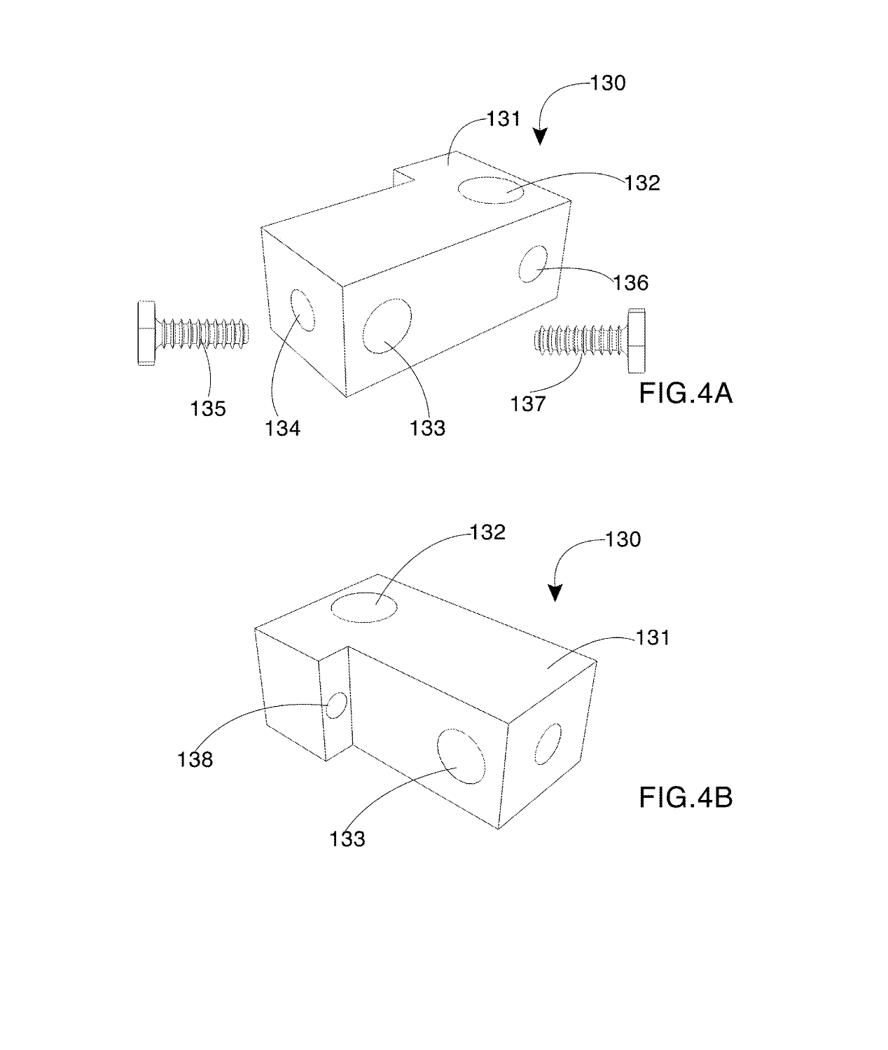

A spray-holster 130 is included with the hand operated painting cart apparatus 100. The spray-holster 130 comprises a body 131 (FIG. 4A) having a paint-aperture 132 (FIG. 4A) and a retaining-aperture 133 (FIG. 4A). The retaining-aperture 133 is configured to retain the spray-holster 130 to the wheeled base 110. The paint-aperture 132 is configured to retain a paint gun 60 to the spray-holster 130. The paint gun 60 configured to be actuated by the second-wire 124.

A fifth-wheel assembly 200 is further included with the hand operated painting cart apparatus 100. The fifth-wheel assembly 200 is affixed to the wheeled base 110. The fifth-wheel assembly 200 may be attached to the wheeled base 110 with a plurality of fasteners 80. Alternatively, the fifth-wheel assembly 200 may be welded on to the wheeled base 110. Further methods to attach the fifth-wheel assembly 200 to the wheeled base 110 are considered. The fifth-wheel assembly 200 includes a wheel 222 that may be activated by the user 40 to engage and disengage the ground 60. The wheel 222 of the fifth-wheel assembly 200 may be disengaged from the ground by activating the second-hand trigger 123.

According to one embodiment, the hand operated painting cart apparatus 100 may be arranged as a kit 105. In particular, the hand operated painting cart apparatus 100 may further include a set of instructions 107. The instructions 107 may detail functional relationships in relation to the structure of the hand operated painting cart apparatus 100 such that the hand operated painting cart apparatus 100 can be used, maintained, or the like, in a preferred manner.

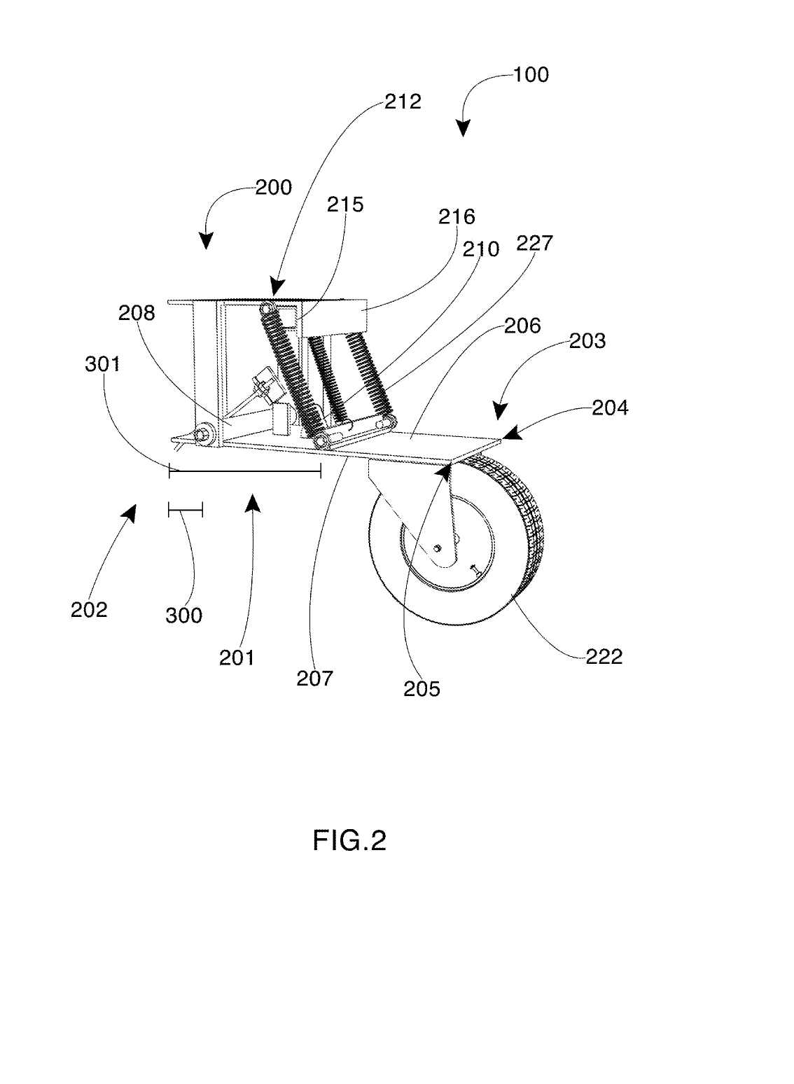

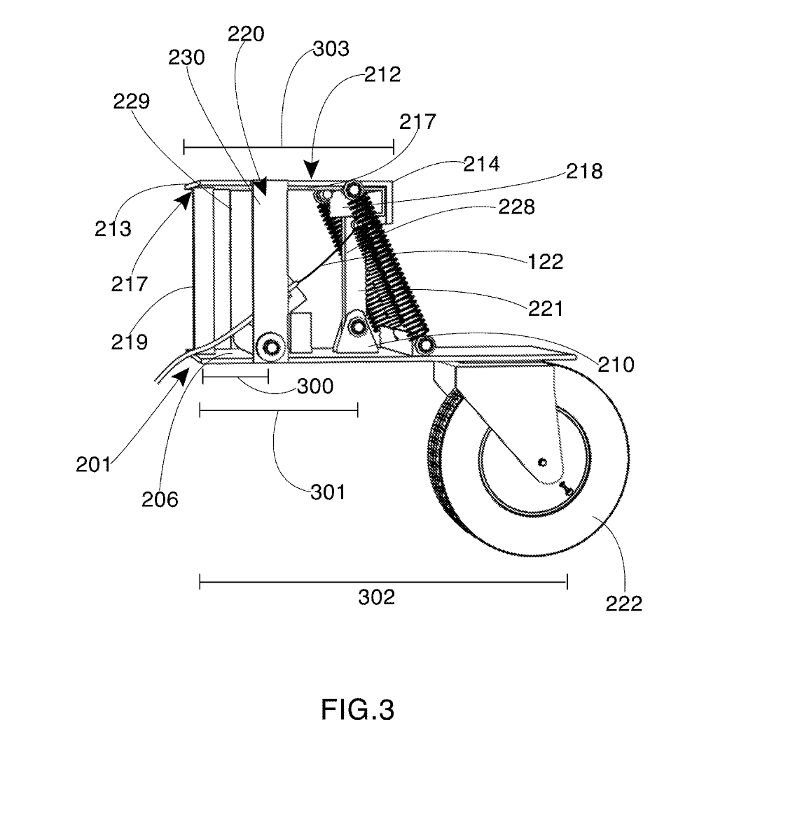

Referring now to FIG. 2 showing the hand operated painting cart apparatus 100 of FIG. 1, according to an embodiment of the present disclosure. As above, the hand operated painting cart apparatus 100 may include a fifth-wheel assembly 200 that is affixed to the wheeled base 110 (FIG. 1). The fifth-wheel assembly 200 includes a lower-platform 201 and an upper-platform 212. The upper-platform 212 is shown having a first-side 216 and a second-side 215. The lower-platform 201 has a lower-length 302 (FIG. 3), a forward-end 202, a rearward-end 203, a right side 204, a left side 205, a top-surface 206, and a bottom-surface 207. The top-surface 206 of the lower-platform 201 includes a tubular pivoting-member 208 extending from the right side 204 to the left side 205. The tubular pivoting-member 208 is disposed a first distance 300 from the forward-end 202. The top-surface 206 further includes a pivot-support 210. The pivot-support 210 is disposed a second distance 301 from the forward-end 202. The wheel 222 is disposed on the bottom-surface 207 of the rearward-end 203 of the lower-platform 201. The lower-platform 201 may be connected to the upper-platform 212 with a first-tension member 227.

FIG. 3 is a view of the hand operated painting cart apparatus 100 of FIG. 1, according to an embodiment of the present disclosure. The upper-platform 212 of the fifth-wheel assembly 200 includes a front-end 213, a back-end 214, a first-side 216 (FIG. 2), a second-side 215 (FIG. 2), and a lower-surface 217. The upper-platform 212 may have an upper-length 303. The lower-length 302 of the lower-platform 201 may be greater than the upper-length 303 of the upper-platform 212. The lower-surface 217 includes a back-abutment member 218 disposed from the first-side 216 to the second-side 215 on the back-end 214. A first-abutment member 219 extends perpendicularly from the lower-surface 217 of the front-end 213 of the upper-platform 212. The first-abutment member 219 is configured to abut with the top-surface 206 of the forward-end 202 (FIG. 2) of the lower-platform 201.

A retaining-member 220 is configured to pivotably connect the upper-platform 212 to the tubular pivoting-member 208 (FIG. 2) of the lower-platform 201. The retaining-member 220 is disposed the first distance 300 from the front-end 213. The retaining-member 220 may comprise of a first-leg 229 extending perpendicularly from first-side 216 of the upper-platform 212. The first-leg 229 may be pivotably connected to the tubular pivoting-member 208 disposed on the right side 204 (FIG. 2) of the lower-platform 201 (FIG. 2). The retaining-member 220 may comprise a second-leg 230 extending perpendicularly from the second-side 215 of the upper-platform 212. The second-leg 230 may be pivotably connected to the tubular pivoting-member 208 disposed on the left side 205 (FIG. 2) of the lower-platform 201.

A pivot-arm 221 is pivotably connected to the pivot-support 210 of the lower-platform 201. The pivot-arm 221 is disposed a second-distance 301 from the front-end 213 of the upper-platform 212. The pivot-arm 221 is configured to abut with the back-abutment member 218 member of the upper-platform 212. The pivot-arm 221 is configured to be pulled by the first-wire 122. The first-hand trigger 121 (FIG. 1) retracts the first-wire 122, thereby pivoting the pivot-arm 221. When the pivot-arm 221 is retracted with the first-wire 122 the pivot-arm 221 no longer abuts with the back-abutment member 218. When the pivot-arm 221 no longer abuts with the back-abutment member 218 the lower-platform 201 may rotate and disengage the wheel 222 from the ground 60 (FIG. 1). The pivot-arm 221 may be connected to the lower-platform 201 with a second-tension member 228. The second-tension member 228 may be a spring or another device configured to maintain substantially constant tension between the pivot-arm 221 and the lower-platform 201.

Referring now to FIG. 4A and FIG. 4B showing views of the hand operated painting cart apparatus 100 of FIG. 1, according to an embodiment of the present disclosure. Here shown are views of the spray-holster 130. The spray-holster 130 comprises a body 131 having a paint-aperture 132 and a retaining-aperture 133. The retaining-aperture 133 is configured to retain the spray-holster 130 to the wheeled base 110 (FIG. 1). The paint-aperture 132 is configured to retain a paint gun 60 (FIG. 1) to the spray-holster 130. The paint gun 60 is configured to be actuated by the second-wire 124 (FIG. 1). The spray-holster 130 may include a threaded set-retaining aperture 134 configured for a first-set-screw 135. The first-set-screw 135 may be configured to retain the spray-holster 130 to the wheeled base 110. The spray-holster 130 may include a threaded set-gun aperture 136 configured for a second-set-screw 137. The second-set-screw 137 may be inserted into the threaded set-gun aperture 136 to retain the paint gun 60 within the paint-aperture 132 of the spray-holster 130. The spray-holster 130 may further include an aperture 138 configured to receive the second-wire 124 such that the second-wire 124 may operate a trigger on the paint gun 60.

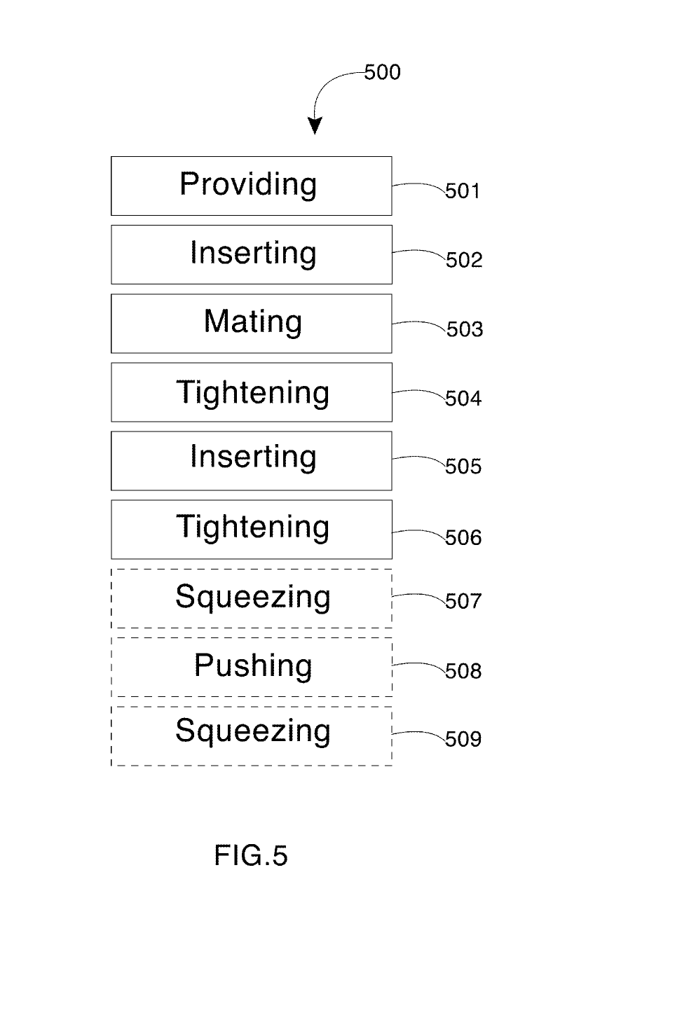

FIG. 5 is a flow diagram illustrating a method for using 500 a hand operated painting cart apparatus 100, according to an embodiment of the present disclosure. In particular, the method for using 500 a hand operated painting cart apparatus 100 may include one or more components or features of the hand operated painting cart apparatus 100 as described above. As illustrated, the method for using 500 a hand operated painting cart apparatus 100 may include the steps of: step one 501, providing a hand operated painting cart apparatus as described above; step two 502, inserting the paint gun into the paint-aperture of the spray-holster; step three 503, mating the spray-holster to the frame through the retaining-aperture; step four 504 tightening the first-set-screw into the threaded set-retaining aperture to secure the spray-holster to the frame; step five 505, inserting the paint gun into the paint-aperture; step six 506, tightening the second-set-screw in in the threaded set-gun aperture to secure the spray-holster to the frame; step seven 507, squeezing the first-hand trigger to disengage the wheel from the ground; step eight 508, pushing the top-surface of the lower-platform of the fifth-wheel assembly to engage the wheel with the ground; step nine 509, squeezing the second-hand trigger to activate the paint gun.

It should be noted that step 507, 508, and 509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a hand operated wheeled spraying apparatus are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wheeled spraying apparatus, the apparatus comprising:
a wheeled base, the wheeled base comprising a frame, a front pair of wheels connected by a front axle, and a rear pair of wheels connected by a rear axle, the wheeled base including at least one basket;
a handle, the handle connected to the wheeled base and configured to be gripped by a user, the handle including:
a first-hand trigger, the first-hand trigger disposed on the handle and configured to pull a first-wire;
a second-hand trigger, the second-hand trigger disposed on the handle and configured to pull a second-wire;
a spray-holster, the spray-holster comprising a body having a paint-aperture and a retaining-aperture, the retaining-aperture configured to retain the spray-holster to the wheeled base, the paint-aperture configured to retain a paint gun to the spray-holster, the paint gun configured to be actuated by the second-wire; and,
a fifth-wheel assembly affixed to the wheeled base, the fifth-wheel assembly including:
a lower-platform, the lower-platform having a forward-end, a rearward-end, a right side, a left side, a top-surface, and a bottom-surface, the top-surface including a tubular pivoting-member extending from the right side to the left side a first distance from the forward-end, the top-surface further including a pivot-support being a second distance from the forward-end;
an upper-platform, the upper-platform having a front-end, a back-end, a first-side, a second-side, and a lower-surface including a back-abutment member disposed from the first-side to the second-side on the back-end;
a first-abutment member, the first-abutment member extending perpendicularly from the lower-surface of the front end of the upper-platform, the first-abutment member configured to abut with the top-surface of the forward-end of the lower-platform;
a retaining-member, the retaining-member configured to pivotably connect the upper-platform to the tubular pivoting-member of the lower-platform, the retaining-member disposed the first distance from the front-end;
a pivot-arm, the pivot-arm pivotably connected to the pivot-support of the lower-platform and configured to abut with the back-abutment member of the upper-platform, the pivot-arm configured to be pulled by the first-wire;
a wheel, the wheel disposed on the bottom-surface of the rearward-end of the lower-platform; and
wherein the wheeled spraying apparatus is configured to allow a user to use the first-hand trigger to actuate the wheel and the second-hand trigger to actuate the paint gun.

2. The wheeled spraying apparatus of claim 1, wherein the frame includes at least one surface configured to carry a compressor and a paint reservoir.

3. The wheeled spraying apparatus of claim 1, wherein the frame is made of steel, and alternatively, a rigid material.

4. The wheeled spraying apparatus of claim 1, wherein the first-wire includes a rigid first-sheath configured to protect the first-wire.

5. The wheeled spraying apparatus of claim 1, wherein the second-wire includes a rigid second-sheath configured to protect the second-wire.

6. The wheeled spraying apparatus of claim 1, wherein the lower-platform has a lower-length.

7. The wheeled spraying apparatus of claim 1, wherein the upper-platform has an upper-length.

8. The wheeled spraying apparatus of claim 6, wherein the lower-length is greater than the upper-length.

9. The wheeled spraying apparatus of claim 1, wherein the lower-platform is connected to the upper-platform with a first-tension member.

10. The wheeled spraying apparatus of claim 1, wherein the pivot-arm is connected to the lower-platform with a second-tension member.

11. The wheeled spraying apparatus of claim 1, wherein the retaining-member comprises a first-leg extending perpendicularly from first-side of the upper-platform, the first-leg pivotably connected to the tubular pivoting-member disposed on the right side of the lower-platform.

12. The wheeled spraying apparatus of claim 1, wherein the retaining-member comprises a second-leg extending perpendicularly from the second-side of the upper-platform, the second-leg pivotably connected to the tubular pivoting-member disposed on the left side of the lower-platform.

13. The wheeled spraying apparatus of claim 1, wherein the spray-holster further includes an aperture configured to receive the second wire such that the second wire may operate a trigger on the paint gun.

14. The wheeled spraying apparatus of claim 1, wherein the spray-holster includes a threaded set-retaining aperture configured for a first-set-screw, where the first-set-screw retains the spray-holster to the wheeled base.

15. The wheeled spraying apparatus of claim 1, wherein the spray-holster includes a threaded set-gun aperture configured for a second-set-screw, where the second-set-screw retains the paint gun within the paint-aperture of the spray-holster.

16. The wheeled spraying apparatus of claim 1, wherein the wheel spraying apparatus includes a plurality of fasteners.

17. A wheeled spraying apparatus, the apparatus comprising:
a wheeled base, the wheeled base comprising a frame, a front pair of wheels connected by a front axle, and a rear pair of wheels connected by a rear axle the wheeled base including at least one basket;
a handle, the handle connected to the wheeled base and configured to be gripped by a user, the handle including:
a first-hand trigger, the first-hand trigger disposed on the handle and configured to pull a first-wire;
a second-hand trigger, the second-hand trigger disposed on the handle and configured to pull a second-wire;
a spray-holster, the spray-holster comprising a body having a paint-aperture and a retaining-aperture, the retaining-aperture configured to retain the spray-holster to the wheeled base, the paint-aperture configured to retain a paint gun to the spray-holster, the paint gun configured to be actuated by the second-wire; and,
a fifth-wheel assembly affixed to the wheeled base, the fifth-wheel assembly including:
a lower-platform, the lower-platform having a forward-end, a rearward-end, a right side, a left side, a top-surface, and a bottom-surface, the top-surface including a tubular pivoting-member extending from the right side to the left side a first distance from the forward-end, the top-surface further including a pivot-support being a second distance from the forward-end;
an upper-platform, the upper-platform having a front-end, a back-end, a first-side, a second-side, and a lower-surface including a back-abutment member disposed from the first-side to the second-side on the back-end;
a first-abutment member, the first-abutment member extending perpendicularly from the lower-surface of the front-end, the first-abutment member configured to abut with the top-surface of the forward-end of the lower-platform;
a retaining-member, the retaining-member configured to pivotably connect the upper-platform to the tubular pivoting-member of the lower-platform, the retaining-member disposed a first distance from the front-end;
a pivot-arm, the pivot arm pivotably connected to the pivot-support of the lower-platform and configured to abut with the back-abutment member of the upper-platform, the pivot-arm configured to be pulled by the first-wire;
a wheel, the wheel disposed on the bottom-surface of the rearward-end of the lower-platform; and,
wherein the wheeled spraying apparatus is configured to allow a user to use the first-hand trigger to actuate the wheel and the second-hand trigger to actuate the paint gun;
wherein the frame includes at least one surface configured to carry a compressor and a paint reservoir;
wherein the frame is made of steel, and alternatively, a rigid material;
wherein the first-wire includes a rigid first-sheath configured to protect the first-wire;
wherein the second-wire includes a rigid second-sheath configured to protect the second-wire;
wherein the lower-platform has a lower-length;
wherein the upper-platform has an upper-length;
wherein the lower-length is greater than the upper-length;
wherein the lower-platform is connected to the upper-platform with a first-tension member;
wherein the pivot-arm is connected to the lower-platform with a second-tension member;
wherein the retaining-member comprises a first-leg extending perpendicularly from first-side of the upper-platform, the first-leg pivotably connected to the tubular pivoting-member disposed on the right side of the lower-platform;
wherein the retaining-member comprises a second-leg extending perpendicularly from the second-side of the upper-platform, the second-leg pivotably connected to the tubular pivoting-member disposed on the left side of the lower-platform;
wherein the spray-holster further includes an aperture configured to receive the second wire such that the second wire may operate a trigger on the paint gun;
wherein the spray-holster includes a threaded set-retaining aperture configured for a first-set-screw, where the first-set-screw retains the spray-holster to the wheeled base;
wherein the spray-holster includes a threaded set-gun aperture configured for a second-set-screw, where the second-set-screw retains the paint gun within the paint-aperture of the spray-holster; and
wherein the wheel spraying apparatus includes a plurality of fasteners.

18. The apparatus of claim 17, further comprising set of instructions; and
wherein the apparatus is arranged as a kit.

19. A method of using a wheeled spraying apparatus, the method comprising the steps of:
providing a wheeled spraying apparatus, the wheeled spraying apparatus comprising a wheeled base, the wheeled base comprising a frame, a front pair of wheels connected by a front axle, and a rear pair of wheels connected by a rear axle the wheeled base including at least one basket; a handle, the handle connected to the wheeled base and configured to be gripped by a user, the handle including: a first-hand trigger, the first-hand trigger disposed on the handle and configured to pull a first-wire; a second-hand trigger, the second-hand trigger disposed on the handle and configured to pull a second-wire; a fifth-wheel assembly affixed to the wheeled base, the fifth-wheel assembly including: a lower-platform, the lower-platform having a forward-end, a rearward-end, a right side, a left side, a top-surface, and a bottom-surface, the top-surface including a tubular pivoting-member extending from the right side to the left side a first distance from the forward-end, the top-surface further including a pivot-support being a second distance from the forward-end; an upper-platform, the upper-platform having a front-end, a back-end, a first-side, a second-side, and a lower-surface including a back-abutment member disposed from the first-side to the second-side on the back-end; a first-abutment member, the first-abutment member extending perpendicularly from the lower-surface of the front end, the first-abutment member configured to abut with the top-surface of the forward-end of the lower-platform; a retaining-member, the retaining-member configured to pivotably connect the upper-platform to the tubular pivoting-member of the lower-platform, the retaining-member disposed a first distance from the front-end; a pivot-arm, the pivot arm pivotably connected to the pivot-support of the lower-platform and configured to abut with the back-abutment member of the upper-platform, the pivot-arm configured to be pulled by the first-wire; and, a wheel, the wheel disposed on the bottom-surface of the rearward-end of the lower-platform; and, a spray-holster, the spray-holster comprising a body having a paint-aperture and a retaining-aperture, the retaining-aperture configured to retain the spray-holster to the wheeled base, the paint-aperture configured to retain a paint gun to the spray-holster, the paint gun configured to be actuated by the second-wire; wherein the wheeled spraying apparatus is configured to allow a user to use the first-hand trigger to actuate the wheel and the second-hand trigger to actuate the paint gun;
inserting the paint gun into the paint-aperture of the spray-holster;
mating the spray-holster to the frame through the retaining-aperture;
tightening the first-set-screw into the threaded set-retaining aperture to secure the spray-holster to the frame;
inserting the paint gun into the paint-aperture; and
tightening the second-set-screw in in the threaded set-gun aperture to secure the spray-holster to the frame.

20. The method of claim 19, further comprising the steps of:
squeezing the first-hand trigger to disengage the wheel from the ground;
pushing the top-surface of the lower-platform of the fifth-wheel assembly to engage the wheel with the ground; and
squeezing the second-hand trigger to activate the paint gun.
